(19) United States
(12) Patent Application Publication
(10) Pub. No.: US 2020/0105076 A1
(43) Pub. Date: Apr. 2, 2020

(54) IDENTITY VERIFICATION METHOD, APPARATUS AND SYSTEM AND NON-TRANSITORY COMPUTER READABLE MEDIUM THEREOF

(71) Applicant: UTECHZONE CO., LTD., New Taipei City (TW)

(72) Inventor: Chia-Chun Tsou, New Taipei City (TW)

(73) Assignee: UTECHZONE CO., LTD., New Taipei City (TW)

(21) Appl. No.: 16/701,105

(22) Filed: Dec. 2, 2019

Related U.S. Application Data
(62) Division of application No. 15/371,184, filed on Dec. 6, 2016.

(30) Foreign Application Priority Data
Dec. 7, 2015 (TW) 104140914
Dec. 14, 2015 (TW) 104141870

(51) Int. Cl. G07C 9/00; G06K 9/00; G06F 21/30; G06F 3/0484; G06F 3/01

(52) U.S. Cl. CPC G07C 9/00142; G06K 9/00892; G06K 2009/3291; G06F 3/0484; G06F 3/013; G06F 21/30

(57) ABSTRACT

An identity verification method, apparatus and system and a computer program product are provided. An eye movement tracking algorithm is executed for a face image sequence of a user to detect an eye movement status of the user. A password string is input through the input interface based on the eye movement state to start an eye movement verification procedure. And an autonomous determination procedure is executed based on the eye movement state to determine whether a user is in an autonomous state. When it is determined that the user is in the autonomous state, an operation procedure is started. When it is determined that the user is in a non-autonomous state, a warning signal is generated and the operation procedure is started.

### CROSS-REFERENCE TO RELATED APPLICATION

This application is a divisional application of and claims priority benefit of U.S. application Ser. No. 15/371,184, filed on Dec. 6, 2016, now pending, which claims the priority benefits of Taiwan application serial no. 104140914, filed on Dec. 7, 2015, and Taiwan application serial no. 104141870, filed on Dec. 14, 2015. The entirety of each of the above-mentioned patent applications is hereby incorporated by reference herein and made a part of this specification.

### BACKGROUND OF THE INVENTION

### Field of the Invention

The invention relates to an identity verification mechanism, and particularly relates to an identity verification method, apparatus and system and a non-transitory computer readable medium thereof adopting eye movement input.

### Description of Related Art

Present eye movement tracking techniques are mainly divided into invasive and non-invasive eye movement tracking techniques. The invasive eye movement tracking technique is mainly to set a search coil in the eye or to use an electrooculogram. The non-invasive eye movement tracking technique mainly includes a free-head eye tracking technique or a head-mount eye tracking technique. Along with development of technology, the eye movement tracking techniques are widely applied in various fields, for example, neuroscience, psychology, industrial engineering, human factors engineering, marketing & advertising, computer science, etc.

People who is inconvenient to talk or has physical difficulties may conduct communication and get things done with assistance of the eye movement technique, which brings a lot of convenience to person with limited physical mobility. For example, with assistance of eye movement electronic products, the eye of the user may replace a mouse to implement functions of communication, accessing the Internet and enjoying audio and video entertainment, etc.

### SUMMARY OF THE INVENTION

The invention is directed to an identity verification method, apparatus and system and a non-transitory computer readable medium thereof, which are adapted to input a password according to an eye movement state, such that the password input is diversified.

The invention provides an identity verification method including following steps. An eye movement tracking algorithm is executed to a face image sequence of a user to detect an eye movement state of the user. A password string is input through an input interface based on the eye movement state to start an eye movement verification procedure. An autonomous determination procedure is executed based on the eye movement state to determine whether the user is in an autonomous state or a non-autonomous state to perform the eye movement verification procedure. When it is determined that the user is in the autonomous state to perform the eye movement verification procedure, an operation procedure is started. When it is determined that the user is in the non-autonomous state to perform the eye movement verification procedure, a warning signal is generated and the operation procedure is started.

In an embodiment of the invention, the identity verification method further includes following steps. A hand image of the user is analyzed to determine whether a biological feature is matched with a predetermined feature. When the biological feature is matched with the predetermined feature, the input interface is displayed, where the biological feature is a fingerprint feature or a palm print feature.

In an embodiment of the invention, the identity verification method further includes following steps. The face image sequence is analyzed to determine whether a biological feature is matched with a predetermined feature. When the biological feature is matched with the predetermined feature, the input interface is displayed, where the biological feature is a facial feature, an iris feature, or a sclera vascular texture feature.

In an embodiment of the invention, the step of executing the autonomous determination procedure based on the eye movement state includes: determining whether a help option in the input interface is triggered based on the eye movement state; and determining the user to be in the non-autonomous state when the help option is triggered.

In an embodiment of the invention, the step of executing the autonomous determination procedure based on the eye movement state includes: determining the user to be in the autonomous state when the password string is matched with a first string, and opening all access rights of the operation procedure; and determining the user to be in the non-autonomous state when the password string is matched with a second string, and opening a part of the access rights of the operation procedure.

In an embodiment of the invention, the input interface includes a password input block and a non-password input block, the password input block is used for providing input of the password string. The step of executing the autonomous determination procedure based on the eye movement state includes: determining whether the non-password input block is selected based on the eye movement state; and determining the user to be in the non-autonomous state when the number of times that the non-password input block is clicked is matched with a predetermined number of times.

In an embodiment of the invention, the step of inputting the password string through the input interface based on the eye movement state includes: determining the eye movement state when an eye of the user gazes at one of a plurality of input units in the input interface, where the eye movement state includes at least one of a gazing time, a pupil displacement amount, a pupil moving direction; and determining the input unit to be output based on the eye movement state.

The invention provides an identity verification apparatus including a display unit, an image capturing unit and a control unit. The display unit displays an input interface. The image capturing unit captures a face image sequence. The control unit is coupled to the display unit and the image capturing unit. The control unit executes an eye movement tracking algorithm to the face image sequence to detect an eye movement state of the user, and inputs a password string through an input interface based on the eye movement state to start an eye movement verification procedure. The control unit executes an autonomous determination procedure based on the eye movement state to determine whether the user is in an autonomous state or a non-autonomous state to perform the eye movement verification procedure. When it is determined that the user is in the autonomous state to perform the eye movement verification procedure, the control unit starts an operation procedure. When it is determined that the user is in the non-autonomous state to perform the eye movement verification procedure, the control unit sends a warning signal and starts the operation procedure.

The invention provides a non-transitory computer readable medium record at least one program instruction, and the steps of the aforementioned identity verification method are executed after the program instruction is loaded to an electronic apparatus.

The invention provides an identity verification system including a local device and a server device. The local device includes a display unit used for displaying an input interface, a biological identifier used for capturing a hand image of a user, and an image capturing unit used for capturing a face image sequence. The server device is connected to the local device through the Internet, so as to receive the hand image and the face image sequence from the local device. The server device includes a control unit. The control unit analyzes the hand image and the face image sequence to determine whether a biological feature is matched with a predetermined feature, and executes an eye movement tracking algorithm to the face image sequence to detect an eye movement state of the user, and obtains a password string based on the eye movement state. After determining that the biological feature is matched with the predetermined feature, the control unit controls the local device to display the input interface on the display unit, and inputs a password string through the input interface to start an eye movement verification procedure.

According to the above description, by using the biological feature in collaboration with the eye movement tracking algorithm to perform the identity verification, not only security is improved, operation diversity is also increased.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an identity verification apparatus according to an embodiment of the invention.

FIG. 2 is a flowchart illustrating an identity verification method according to an embodiment of the invention.

FIG. 3 is a flowchart illustrating an identity verification method according to another embodiment of the invention.

FIG. 4 is a block diagram of an identity verification system according to an embodiment of the invention.

### DESCRIPTION OF EMBODIMENTS

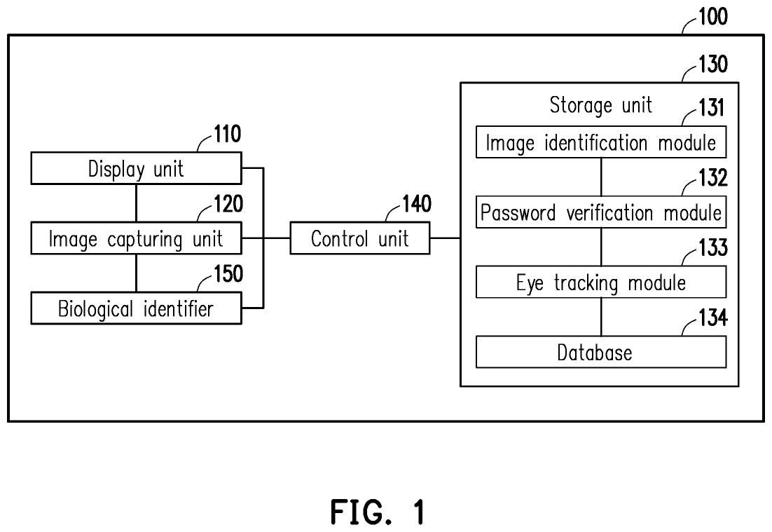

FIG. 1 is a block diagram of an identity verification apparatus according to an embodiment of the invention. Referring to FIG. 1, the identity verification apparatus 100 includes a display unit 110, an image capturing unit 120, a storage unit 130, a control unit 140 and a biological identifier 150. The control unit 140 is coupled to the display unit 110, the image capturing unit 120, the storage unit 130 and the biological identifier 150.

The display unit 110 is used for displaying a graphical interface such as an input interface to facilitate a user to perform operations by viewing an image displayed on the display unit 110. The display unit 110 can be any type of a display, for example, a liquid crystal display (LCD), a light-emitting diode (LED) display or a flexible display.

The image capturing unit 120 is used for capturing a face image sequence of the user. The image capturing unit 120 is, for example, a video camera, a camera, etc. adopting a charge coupled device (CCD) lens, a complementary metal oxide semiconductor transistors (CMOS) lens.

The storage unit 130 is, for example, a fixed or movable random access memory (RAM) of any type, a read-only memory (ROM), a flash memory, a hard disk or other similar devices or a combination of the above devices.

The control unit 140 is, for example, a central processing unit (CPU), a graphic processing unit (GPU), a physics processing unit (PPU), a programmable microprocessor, an embedded control chip, a digital signal processor (DSP), application specific integrated circuits (ASIC), or other similar devices.

The storage unit 130 includes an image identification module 131, a password verification module 132 and an eye tracking module 133, which are respectively composed of a plurality of program instructions, and the control unit 140 executes the aforementioned modules to respectively implement a plurality of functions. The storage unit 130 may further include a database 134 to store account data of qualified users. In other embodiments, the image identification module 131, the password verification module 132 and the eye tracking module 133 can also be chipsets respectively composed of a plurality of digital logic gates. The control unit 140 executes the image identification module 131, the password verification module 132 and the eye tracking module 133 to implement the related operation procedures.

The eye tracking module 133 executes an eye movement tracking algorithm to the face image sequence to detect an eye movement state of the user. Moreover, the eye tracking module 133 detects a plurality of gaze positions of the user on the input interface, and detects the eye movement state, so as to input a password string through the input interface. The eye movement state includes at least one of a gazing time, a pupil displacement amount, a pupil moving direction. The eye tracking module 133 determines the eye movement state of the user when the eye of the user gazes one of a plurality of input units (for example, digits or symbols) included in the input interface, and determines one of the digits or symbols to be output based on the eye movement state. For example, a selected candidate word is determined according to the pupil displacement amount and the pupil moving direction and the gazing position, and the input instruction is determined according to a predetermined gazing time.

The password verification module 132 executes a password verification procedure. The password verification module 132 verifies whether the input password string is matched with a predetermined password of the qualified user. The image identification module 131 analyzes a hand image of the user to determine whether the user is the qualified user admitted by the identity verification apparatus 100. For example, it is determined whether a biological feature of the user is matched with a predetermined feature, where the biological feature is, for example, a fingerprint feature or a palm print feature.

The biological identifier 150 includes (but not limited to) a capacitive sensor or an optical sensor. The biological identifier 150 is used to obtain a fingerprint image or a palm print image. For example, when the user presses a surface of the capacitive sensor by using a finger or a palm, a fingerprint image or a palm print image is obtained based on different charge amount (or temperature difference) generated due to gathering of peaks and troughs of the fingerprint or the palm print. Moreover, when the user presses the surface of the optical sensor by using the finger or the palm, a fingerprint image or a palm print image is obtained through absorption and spoil of total reflection by the peaks and troughs of the fingerprint or the palm print, and then a camera module captures and outputs the image.

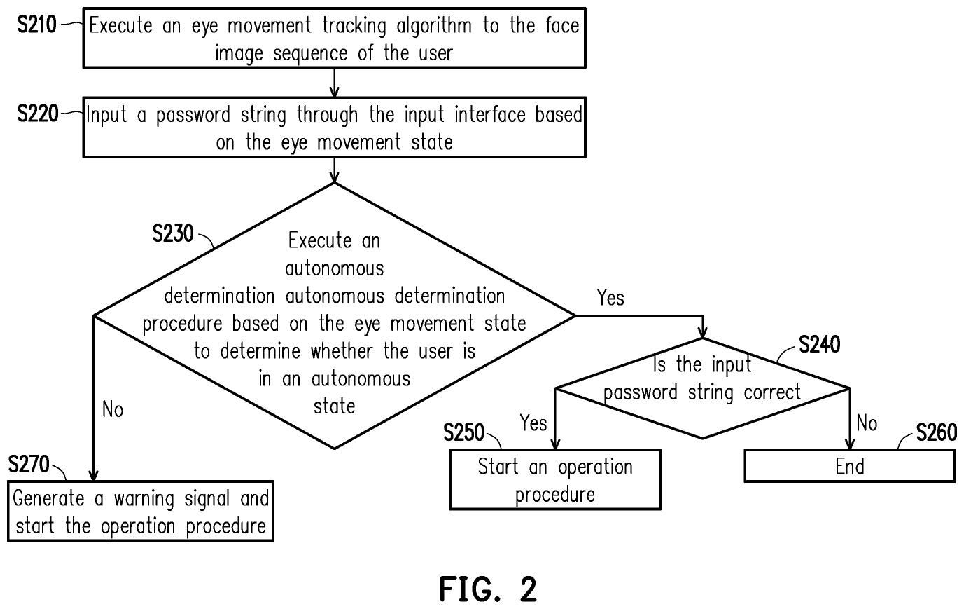

Steps of the identity verification method are described below with reference of the aforementioned identity verification apparatus 100. FIG. 2 is a flowchart illustrating an identity verification method according to an embodiment of the invention. Referring to FIG. 1 and FIG. 2, in step S210, the control unit 140 executes the eye movement tracking algorithm to the face image sequence of the user to detect the eye movement state of the user. Namely, the control unit 140 drives the eye tracking module 133 to execute the eye movement tracking algorithm.

Then, in step S220, the control unit 140 inputs a password string through the input interface based on the eye movement state to start an eye movement verification procedure.

In step S230, the controller 140 executes an autonomous determination procedure based on the eye movement state to determine whether the user is in an autonomous state or a non-autonomous state to perform the eye movement verification procedure. For example, the control unit 140 determines whether the eye movement state is matched with a predetermined condition, so as to determine whether the user is in the autonomous state or the non-autonomous state. In this way, a situation that the user performs the identity verification procedure under coercion is prevented.

When it is determined that the user is in the autonomous state to perform the eye movement verification procedure, in step S240, the password verification module 132 further determines whether the input password string is correct. If the password verification module 132 determines that the input password string is correct, in step S250, the control unit 140 starts an operation procedure. The operation procedure is, for example, an unlock procedure, a financial transaction procedure, etc. Moreover, if the password verification module 132 determines that the input password string is not correct, in step S260, the control unit 140 ends the flow for identity verification.

Conversely, when it is determined that the user is in the non-autonomous state to perform the eye movement verification procedure, in step S270, the control unit 140 generates a warning signal and starts the operation procedure.

The method of performing the autonomous determination procedure based on the eye movement state is described below.

In an exemplary embodiment of the invention, a help option is configured in the input interface, and when the user performs an operation of the non-autonomous, for example, under the coercion, the user may trigger the help option through an eye movement input. The controller 140 determines whether the help option in the input interface is triggered based on the eye movement state. When the help option is triggered, the control unit 140 determines that the user is currently in the non-autonomous state. Then, the identity verification apparatus 100 generates and sends a warning signal to a security device. Moreover, when it is determined that the user is currently in the non-autonomous state, if the password string of the eye movement input is correct, the control unit 140 still starts the subsequent operation procedure.

Furthermore, two sets of predetermined passwords can be set in advance, where one set (a first string) is for the use of the user when the user operates in the autonomous state, and another set (a second string) is for the use of the user when the user operates in the non-autonomous state, for example, under coercion. Moreover, the two sets of the predetermined passwords respectively have different access rights. To be specific, the user inputs a password string to the password verification module 160 to execute the password verification procedure through the eye movement input. When the password string is matched with the first string, the control unit 140 determines that the user is in the autonomous state, and opens all access rights of the operation procedure. When the password string is matched with the second string, it represents that the user currently operates under non-autonomous, and the control unit 140 determines that the user is in the non-autonomous state, and opens a part of the access rights of the operation procedure.

Further, it can be further set as follows: when the user clicks the non-password input block by using the eye movement input, and the number of times for clicking exceeds a predetermined number of times, it is determined that the user is in the non-autonomous state. To be specific, the input interface includes the password input block and the non-password input block, and the password input block is used for inputting the password string. The control unit 140 determines whether the non-password input block is selected based on the eye movement state, and when it is determined that the number of times for the non-password input block being clicked is matched with the predetermined number of times, the control unit 140 determines that the user is in the non-autonomous state.

Furthermore, in order to ensure security of the identity verification procedure, the identity verification apparatus 100 further performs a verification procedure to a biological feature of the user, so as to determine whether the user is a qualified user. For example, the control unit 140 may determine whether the biological feature of the user is matched with a predetermined feature, and accordingly determines whether the user is a qualified user. Another embodiment is provided below for description.

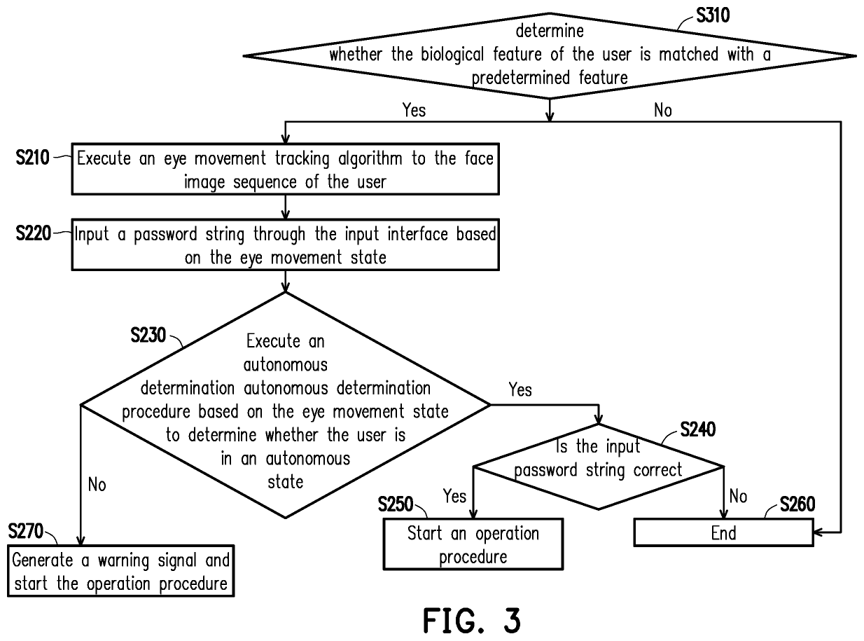

FIG. 3 is a flowchart illustrating an identity verification method according to another embodiment of the invention. In the present embodiment, the steps that are the same with that of FIG. 2 are denoted by the same referential numbers, and descriptions thereof are not repeated.

Referring to FIG. 1 and FIG. 3, in step S310, the control unit 140 analyzes the hand image of the user to determine whether the biological feature of the user is matched with the predetermined feature. Namely, the image identification module 131 first determines whether user is a qualified user. If the user is determined to be the qualified user, the eye tracking module 133 is driven to detect the eye movement state of the user, and the steps S210-S270 are executed. Conversely, if the user is not determined to be the qualified user, in step S260, the flow of identity verification is ended.

In step S320, after the image identification module 131 determines that the biological feature is matched with the predetermined feature, the control unit 140 displays the input interface on the display unit 110 to facilitate the user to input the password string through the input interface based on the eye movement input manner. Then, the control unit 140 executes the autonomous determination procedure and the password verification procedure of the steps S210-S270, and the steps S210-S270 in FIG. 3 are the same or similar to the steps S210-S270 in FIG. 2, so that details thereof are not repeated.

For example, the aforementioned biological feature is, for example, a fingerprint feature or a palm print feature. For example, the image identification module 131 determines whether the user is a qualified user based on the predetermined features in the database 134, i.e. the image identification module 131 determines whether the fingerprint feature or the palm print feature is matched with the predetermined feature. If it is determined that the user is not a qualified user, the image identification module 131 ends the flow of the identity verification (the step S260). If the fingerprint feature or the palm print feature is matched with the predetermined feature, it is preliminarily determined that the user is the qualified user, and the eye tracking module 133 is driven. Moreover, the image identification module 131 may further read a predetermined password corresponding to the qualified user, and sends the predetermined password to the password verification module 132 for subsequent comparison.

However, the method of the verification procedure of the biological feature is not limited by the invention. For example, in another exemplary embodiment, the image identification module 131 analyzes the face image sequence to determine whether the biological feature of the user is matched with the predetermined feature. In the exemplary embodiment, the biological feature is one of a facial feature, an iris feature, a sclera vascular texture feature or a combination thereof. For example, in case that face feature of the face image sequence is matched with a predetermined face image feature (the predetermined feature), and the iris feature is matched with an iris image feature (the predetermined feature), the user is determined to be the qualified user.

Moreover, the aforementioned identity verification method can also be executed by a remote server device, and the local device is only in charge of capturing the hand image and the face image sequence, and displaying the input interface and outputting a result. Another embodiment is provided below for further description.

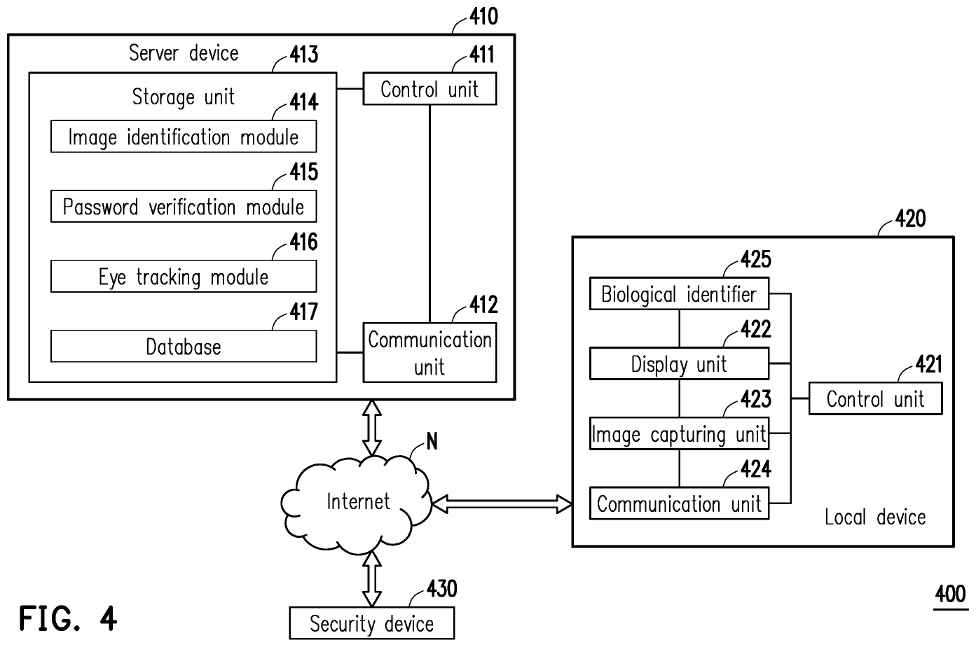

FIG. 4 is a block diagram of an identity verification system according to another embodiment of the invention. Referring to FIG. 4, the identity verification system 400 includes a server device 410, a local device 420 and a security device 430. The server device 410, the local device 420 and the security device 430 are electronic devices having a computation function, and may communicate with each other through the Internet N. The security device 430 is, for example, a server of a police office, or a server of a financial institution.

The server device 410 includes a control unit 411, a communication unit 412 and a storage unit 413. The control unit 411 and the storage unit 413 are respectively similar to the control unit 140 and the storage unit 130. The storage unit 413 includes an image identification module 414, a password verification module 415, an eye tracking module 416 and a database 417, and related description thereof may refer to the aforementioned image identification module 131, the password verification module 132, the eye tracking module 133 and the database 134.

The local device 420 includes a control unit 421, a display unit 422, an image capturing unit 423, a communication unit 424 and a biological identifier 425. The communication unit 412 and the communication unit 424 are, for example, wired or wireless network cards.

In the present embodiment, the local device 420 is only in charge of capturing the hand image and the face image sequence, and then the hand image and the face image sequence are sent to the server device 410 through the communication unit 424, and the server device 410 executes the identity verification procedure.

To be specific, the control unit 421 of the local device 420 first drives the biological identifier 425 to obtain the hand image of the user, and drives the image capturing unit 423 to capture the face image sequence, and sends the hand image and the face image sequence to the server device 410. Then, the control unit 411 of the server device 410 analyzes the hand image or a face image to determine whether the biological feature is matched with the predetermined feature, and transmits an analysis result to the local device 420. If the analysis result indicates that the biological feature is matched with the predetermined feature, the control unit 421 of the local device 420 displays an input interface on the display unit 422 to facilitate the user inputting a password string through the input interface based on the eye movement input method. Moreover, it can be further set as follows: when the analysis result indicates that the biological feature is not matched with the predetermined feature, the control unit 421 of the local device 420 does not display the input interface.

After the input interface is displayed, the control unit 411 of the server device 410 executes an eye movement tracking algorithm to the face image sequence to detect an eye movement state of the user, so as to obtain the password string based on the eye movement state, and execute the subsequent autonomous determination procedure and the password verification procedure.

The invention further provides a non-transitory computer readable medium adapted to the identity verification apparatus. The non-transitory computer readable medium records at least one program instruction. The aforementioned program instruction is composed of a plurality of program instructions (for example, an organization chart establishing program instruction, a table approving program instruction, a setting program instruction, and a deployment program instruction, etc). When the program instruction is located into an electronic device, the aforementioned identity verification method and the functions of the identity verification apparatus are executed.

In summary, by combining the biological feature and the eye movement tracking algorithm during the identity verification process of the user, the security of the identity verification is greatly improved. Moreover, by using eyeball motions to implement the eye movement input, input operations are diversified. Moreover, in case of a coercion, the eye movement input may trigger a warning signal, such that the people under coercion can ask for help without being perceived by criminals.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An identity verification method, comprising:
executing an eye movement tracking algorithm to a face image sequence of a user to detect an eye movement state of the user;
analyzing the face image sequence to determine whether a biological feature is matched with a predetermined feature; and
displaying a input interface when the biological feature is matched with the predetermined feature, wherein the biological feature is a facial feature, an iris feature, or a sclera vascular texture feature;
inputting a password string through the input interface based on the eye movement state to start an eye movement verification procedure;
executing an autonomous determination procedure based on the eye movement state to determine whether the user is in an autonomous state or a non-autonomous state to perform the eye movement verification procedure;
starting an operation procedure when it is determined that the user is in the autonomous state to perform the eye movement verification procedure; and
generating a warning signal and starting the operation procedure when it is determined that the user is in the non-autonomous state to perform the eye movement verification procedure.

2. The identity verification method as claimed in claim 1, wherein the step of executing the autonomous determination procedure based on the eye movement state comprises:
determining the user to be in the autonomous state when the password string is matched with a first string, and opening all access rights of the operation procedure; and
determining the user to be in the non-autonomous state when the password string is matched with a second string, and opening a part of the access rights of the operation procedure.

3. An identity verification apparatus, comprising:
a display unit, displaying an input interface;
an image capturing unit, capturing a face image sequence of a user; and
a control unit, coupled to the display unit and the image capturing unit,
wherein the control unit analyzes the face image sequence to determine whether a biological feature is matched with a predetermined feature, and displays the input interface when the biological feature is matched with the predetermined feature, wherein the biological feature is a facial feature, an iris feature, or a sclera vascular texture feature;
the control unit executes an eye movement tracking algorithm to the face image sequence to detect an eye movement state of the user, and inputs a password string through an input interface based on the eye movement state to start an eye movement verification procedure;
the control unit executes an autonomous determination procedure based on the eye movement state to determine whether the user is in an autonomous state or a non-autonomous state to perform the eye movement verification procedure; when it is determined that the user is in the autonomous state to perform the eye movement verification procedure, the control unit starts an operation procedure, and when it is determined that the user is in the non-autonomous state to perform the eye movement verification procedure, the control unit sends a warning signal and starts the operation procedure.

4. The identity verification apparatus as claimed in claim 3, wherein when the password string is matched with a first string, the control unit determines the user to be in the autonomous state, and opens all access rights of the operation procedure; and when the password string is matched with a second string, the control unit determines the user to be in the non-autonomous state and opens a part of the access rights of the operation procedure.

5. A non-transitory computer readable medium, records at least one program instruction, and the at least one program instruction is loaded into an electronic apparatus to execute the steps of the claim 1.

6. An identity verification system, comprising:
a local device, comprising:
a display unit, displaying an input interface;
a biological identifier, capturing a hand image of a user; and
an image capturing unit, capturing a face image sequence; and
a server device, connected to the local device through the Internet, so as to receive the hand image and the face image sequence from the local device, and the server device comprising:
a control unit, analyzing the hand image and the face image sequence to determine whether a biological feature is matched with a predetermined feature, and executing an eye movement tracking algorithm to the face image sequence to detect an eye movement state of the user, and obtaining a password string based on the eye movement state,
wherein after the control unit determines that the biological feature is matched with the predetermined feature, the control unit controls the local device to display the input interface on the display unit, and inputs a password string through the input interface to start an eye movement verification procedure.
